(19) United States
(12) Patent Application Publication
(10) Pub. No.: US 2026/0153189 A1
(43) Pub. Date: Jun. 4, 2026

(54) FLUX PINNING SUPERCONDUCTING LH2 TANK

(71) Applicant: ZEROAVIA LTD, Cirencester (GB)

(72) Inventors: Rudolf Jacobus Coertze, Cirencester (GB); Christian Bailey, Hollister, CA (US)

(21) Appl. No.: 19/261,649

(22) Filed: Jul. 7, 2025

Related U.S. Application Data
(62) Division of application No. PCT/US2023/036961, filed on Nov. 7, 2023.
(60) Provisional application No. 63/437,668, filed on Jan. 7, 2023.

(30) Foreign Application Priority Data
Jan. 16, 2023 (GB) 2300636.4
Feb. 13, 2023 (GB) 2302035.7

(51) Int. Cl. F17C 3/04

(52) U.S. Cl. CPC F17C 3/04; F17C 2201/0104; F17C 2203/0337; F17C 2203/0629; F17C 2203/0648; F17C 2203/0656; F17C 2221/012; F17C 2221/017; F17C 2223/0161; F17C 2270/0189

(57) ABSTRACT

A cryogenic storage tank includes an inner wall and an outer wall defining a space, wherein the inner wall and outer wall are spaced from one another by magnetic repulsion. In one embodiment the inner wall includes a high temperature superconducting material embedded in or on a surface of the inner wall, and the outer wall has conventional magnetic embedded in or on a surface of the outer wall.

### CROSS REFERENCE TO RELATED APPLICATIONS

This application is a divisional of U.S. patent application Ser. No. 19/146,147, filed Jul. 7, 2025, which in turn is a national stage application of PCT Patent Application No. PCT/US2023/036961, filed on Nov. 7, 2023, which claims priority to US Provisional Patent Application No. 63/437,668 , filed on Jan. 7, 2023, and UK Patent Application No. 2300636.4 filed on Jan. 16, 2023, and UK Patent Application No. 2302035.7, filed on Feb. 13, 2023, the content of all of which is incorporated herein by reference.

### FIELD OF THE DISCLOSURE

The present disclosure relates to cryogenic storage tanks. The disclosure has particular utility in connection with cryogenic storage tanks for containing highly volatile materials such as liquid hydrogen for powering stationary applications and vehicles such as airplanes, and will be described in connection with such utility, although other utilities are contemplated.

### BACKGROUND AND SUMMARY

This section provides background information related to the present disclosure which is not necessarily prior art. This section provides a general summary of the disclosure and is not a comprehensive disclosure of its full scope or all its features.

There are many types of cryogenic storage tank designs, and some are even semi-structural like Stanley's ingenious design of a vacuum flask from the 1900's, however this design could not be effective at soft or moderate vacuum pressures. Because of this the Stanley design required advanced manufacturing processes, such as furnace welding in a purged environment. Typical prior art cryogenic storage tank formats include:
Vacuum Jacketed Multi-layer insulation (VJ MLI) which has very high thermal performance, but is not thermo structural by design, and is difficult to produce.
Foamglas® for liquid natural gas (LNG), which is thermo structurally not good, heavy, time consuming to produce and not suitable for flight. Additionally, it is made for ambient pressures.
Spray on foam insulation (SOFI) is generally not thermo structural, and is of much lower thermal performance and better suited to ambient pressures.
Perlite or microspheres have been used in soft vacuum (SV) in heavy ground standing double walled tanks but are poured into the annulus as a bulk fill material and do not provide potential structural strength.

The use of cryogenic fluids such as LNG for powering vehicles such as aircraft, or hydrogen for powering fuel cell powered aircraft offer attractive alternatives to conventional liquid fossil fuel burning engines. LNG and liquid hydrogen (LH₂) are stored in a liquid state at very low temperature. For example, liquid hydrogen is stored at below 252° C.; and LNG (predominantly methane) is stored at below −162° C. In order to maintain these fuel stores in the tank in liquid state, the tank must be strong to maintain pressure on the fluid and must be insulated. Typically, cryogenic storage tanks are multiwalled structures with some insulating material between the walls. The space between the tank walls also typically is evacuated, i.e., to form a vacuum.

In the case of an airplane, weight and space also are at a premium. Accordingly, the tank should be as light weight as possible, while still maintaining sufficient structural integrity to contain the liquified fuel stores, and have sufficiently thermal insulating value, and able to withstand temperature cycling, shock, and high G (gravity) loading. That is to say, cryogenic storage tanks must be light weight, strong, and relatively low cost to produce and service.

A conventional cryogenic storage tank 10 is illustrated in FIG. 1 and includes an inner wall 12 and an outer wall 14. Inner wall 12 is separated from outer wall 14 by a plurality of supports or studs 16. The space between inner wall 12 and outer wall 14 is sealed fluid tight and is evacuated, i.e., to form a vacuum. The void 18 between the inner and outer walls 12, 14 also may be filled with a thermal insulating material, or the inner surface 20 of the inner wall 12, the outer surface 22 of outer wall 14, and the walls 24 of the studs 16 may be coated at least in part with insulation.

Referring to FIG. 2, another prior art tank 30 includes an inner wall 32, an outer wall 34 separated from the inner wall. A microsphere powder is loaded in the space 36 between inner and outer walls 32, 34, flowing around the supports 24 to fill the void between the walls 32, 34 spaced from one another.

In accordance with the present disclosure, there is provided a cryogenic storage tank comprising an inner wall and an outer wall defining a space, wherein the space is filled at least in part with a high angle of repose particulate material consisting of dried-in-place hollow glass microspheres which provides both insulating and structural properties to maintain the space.

In one aspect the inner wall and the outer wall are formed of different materials.

In another aspect the inner wall comprises a metal wall and the outer wall comprises a built-up wall including one or more non-metallic layers.

In yet another aspect the inner wall comprises a metal wall and the outer wall comprises one or more layers formed of a metal foil, or one or more layers formed of a fiber reinforced material, or one or more layers of a metal foil and one or more layers formed of a fiber reinforced material.

The present disclosure also provides a method of forming a cryogenic storage tank as above described, comprising providing a first walled structure configured to form the tank inner wall; wrapping the first wall in a flexible bladder; injecting a putty comprising glass microspheres in a volatile organic solvent between the outer wall of the first walled structure and the bladder; driving off the solvent to form a high angle of repose material; removing the bladder; and forming a built-up layer over the glass microspheres to form the tank outer wall; or forming a built-up layer directly over the bladder to form the tank outer wall.

In one aspect of the method, the solvent is driven off by heat, by vacuum, or by a combination of heat and vacuum.

In another aspect of the method, the built-up layer comprises one or more layers formed of a metal foil, or one or more layers formed of fiber reinforced plastic materials, or one or more layers formed of a metal foil and one or more layers formed of a fiber reinforced material.

In another aspect, the method includes adding a thermal insulating layer over the built-up layer.

The present disclosure also provides an alternative method of forming a cryogenic storage tank, comprising providing a first walled structure configured to form the tank inner wall; applying a putty comprising glass microspheres in a volatile organic solvent on an outer wall surface of the first walled structure; applying a release agent over the putty; applying a bladder over the release agent; and heating and/or pulling a vacuum to draw off the organic solvent to form a high angle of repose material, removing the bladder, and forming a built-up layer over the glass microsphere to form the tank outer wall, or forming a built-up layer directly over the bladder to form the tank outer wall.

In one aspect of the alternative method, the built-up layer wall comprises one or more layers formed of a metal foil, one or more layers formed of fiber reinforced plastic materials, one or more layers formed of a metal foil and one or more layers of a fiber reinforced plastic material.

In another aspect, the alternative method involves adding a thermal insulating layer over the built-up layer.

In yet another aspect of the disclosure is provided a fuel cell powered aircraft comprising a cryogenic storage tank as above described.

More particularly, in accordance with the present disclosure, we provide a cryogenic storage tank comprising an inner wall, and an outer wall forming a space between them. The space is filled with a high angle of repose granular material such as hollow glass microspheres, as will be described below. The hollow glass microspheres are available commercially from a variety of sources and usually have diameters ranging from between about 1 and 1,000 micrometers. Hollow glass microspheres, sometimes termed “micro balloons” or “glass bubbles” have been used in the past in composite materials such as syntactic foam and lightweight concrete. They are characterized by having a relatively low thermal conductivity. Glass microspheres typically are made by heating tiny droplets of dissolved water glass in a process known as ultrasonic spray pyrolysis.

A feature and advantage of the present disclosure is by filling the space between the tank walls with glass microspheres, the glass microspheres provide both thermal insulating and structural properties. Thus, structural supports between the tank walls used in prior vacuum cryogenic storage tanks are not necessary. This eliminates weight in the construction of the tanks, and also eliminates potential thermal paths between the inner and outer walls of the tank. Tanks made in accordance with the present disclosure have other advantages. The glass microspheres filling the space between the inner and outer walls of the tank form a high angle of repose material, whereby to create a lightweight strong sandwich composite structure. Also, the outer tank wall does not need to be built to withstand high vacuum pressures or need support to withstand soft/medium vacuum pressures. Thus, further reducing weight and costs.

The overall process is as follows. First a wall structure destined to become the inner wall of a tank is wrapped in a bladder formed of a stretchable but strong material, e.g., latex. Then a microsphere “putty” is created using a volatile organic solvent, such as acetone, to fully saturate a solution of glass microspheres such as 3M™ K1 glass microspheres which have a diameter of approximately 0.05-0.1 mm in a ratio such that the putty is neither too clumpy nor too sticky. In other embodiments, a silica anti-caking agent may be added to the putty. The putty is then inserted (e.g., injected, blown in) directly into the space between the tank inner wall and the elastic latex bladder using, e.g., a texture gun. In another embodiment, the microsphere “putty” can be applied mechanically, e.g., by hand, or by robot over the wall structure destined to become the tank inner wall, and the bladder is then wrapped onto the structure. The microsphere fill is then “wetted out” with volatile organic solvents such as acetone. The tank then may be vibrated or rolled while slowly depressurizing the bladder to evenly distribute the microspheres.

The resulting putty holds its shape and conforms to orifices and complex geometry of the tank.

Also, in the case of larger size tanks, a vacuum may be applied, and a heat/pressure cycle used to consolidate and drive off solvent, in a vacuum baking process, to form the glass microspheres into a high angle of repose material. Once the high angle of repose material sets, the bladder may be removed.

Once the tank inner wall is fully encapsulated by the set high angle repose material, with or without a bladder, it can be sprayed with a suitable setting or curing, low outgassing polymer, e.g., fast cure two-part epoxy strengthener, with two or three coats each reaching tack before continuing. The fast cure spray is then allowed to reach full cure.

From here a composite shell is progressively built-up, starting optionally with layers of, e.g., aluminum foil and epoxy, moving on to fiber reinforced plastics (FRP) such as Carbon Fiber Reinforced Plastics (CFRP) layers in a staged process to create the outer tank wall.

Optionally conventional ambient pressure insulation can then be added such as a spray on SOFI, expanded cork, or NVLCI.

In still yet another embodiment a microsphere “putty” or glass microspheres is created, that is neither too clumpy or too sticky, and the microsphere putty is directly applied to the outer wall of the structure destined to become the tank inner wall. A silica anti-caking agent also may be added to the “putty”. The putty holds its shape and conforms to orifices and complex geometry of the tank wall. Additionally, the putty is such that it may be tailored to specific layer thickness depending on degree of thermal protection required for particular areas of the tank, allowing for a highly optimized product.

Once the tank is sculpted, a release film is applied over the microsphere putty, and using a breather blanket and a vacuum bag to apply vacuum, a heat and external pressure cycle is used to consolidate and drive off the organic solvent, whereby to form the glass microsphere into a high angle of repose material. Upon setting of the high angle of repose material, the breather blanket vacuum bag is removed.

Once the structure is fully encapsulated with the glass microbead high angle of repose material it is sprayed with a suitable setting or curing, low outgassing polymer, with two or three coats each reaching tack before continuing, it is then allowed to reach full cure, as before.

From here a composite shell is progressively built-up, starting optionally with layers of metal foil and polymer, moving on to spray on foam insulation, fiber reinforced plastics layers and non-vacuum layered composite insulation layers in a staged process to create the outer tank wall.

Optionally, conventional ambient pressure insulation can then be added such as a spray on foam insulation, expanded cork, a non-volatile, multi-layered insulation, as before.

In other embodiments, an aerogel may be mixed into the microsphere putty.

In yet other embodiments, an aerogel and other material with desirable structural properties such as a polymer or fibers (e.g., fiberglass) may be mixed into the microsphere putty.

In accordance with the present disclosure, there is provided a cryogenic storage tank comprising an inner wall and an outer wall defining a space, wherein the inner wall and the outer wall are spaced from one another by magnetic repulsion. By spacing the inner wall and the outer wall from one another by magnetic repulsion, cryogenic storage tanks made in accordance with the present disclosure avoid the need for structural supports or studs, significantly reducing the weight of the tank and reducing the thermal losses.

In accordance with the present disclosure, the inner wall of the cryogenic storage tank includes superconducting wire embedded in or on a surface of the inner wall, while the outer wall has magnetic wire or magnets embedded in or on the surface of the outer wall. The outer wall is formed of a material permeable to magnetic fields. The inner wall and outer wall of the cryogenic storage tank are maintained spaced from one another by magnetic repulsion (flux pinning) without the need for internal structural supports or studs.

A superconductor is a material which is characterized by zero electrical resistivity when a temperature of the material is below the material's so-called “critical temperature”. A superconductor also exhibits the property of diamagnetism; that is, superconductors are perfect diamagnets with a magnetic susceptibility of −1. A diamagnet is characterized by the generation of a repulsive force in a material which is subjected to an applied magnetic field. The repulsive force is caused by the quantum mechanical effect by which an applied magnetic field creates an induced magnetic field in the material which is directly opposed to the direction of the applied magnetic field.

Flux pinning is a phenomenon that occurs when flux vortices in a superconductor are prevented from moving within the bulk of the superconductor materials so that the magnetic pins are “pinned” to those locations. This pinning is what holds a superconductor in place thereby allowing it to levitate. In accordance with the present disclosure we maintain spacing between the inner and outer walls of a cryogenic storage tank by affixing superconductor material to the tank inner wall, and conventional magnetic material to the tank outer wall, whereupon the magnetic field from the conventional magnetic material on the tank outer wall induces a magnetic field in the superconductor material creating a strong magnetic repulsive force between the superconductor material on the tank inner wall and the conventional magnetic material on the tank outer wall whereby to maintain spacing between the tank inner and outer wall.

Superconducting materials achieve superconductivity at their so-called “critical temperature”. In the case of type-II superconducting materials, the critical temperature is the boiling point of liquid nitrogen (77.3°K). Since liquid hydrogen boils at 20°K, in accordance with the present disclosure we use the temperature of the stored hydrogen to achieve superconductivity. That is to say, when the superconducting wire on the tank inner wall is cooled to below their critical temperature, e.g., when liquid hydrogen is present in the tank, a repulsive force is generated between the superconducting material on the tank inner wall and the conventional magnetic material on the tank outer wall creating magnetic levitation or repulsion between the inner and outer walls of the tank, maintaining the spacing between the inner and outer tanks.

In accordance with the present disclosure, superconducting material is embedded into or fixed to a surface of a cryogenic storage tank inner wall. Exemplary useful superconducting material include type-II high-temperature superconducting metal and metal alloys selected from the group consisting of NbTi, Nb₃Sn, YBa₂Cu₃Oₓ (YBCO), MgB₂, and Bi₂Sr₂CaO, which are given as exemplary. Some high-temperature superconducting alloys (e.g., YBCO) are not easy to manufacture, as they require nearly perfect crystallinity combined with a very dense array of artificial pinning centers. Thus, some embodiments may incorporate Y₂O₃ nanoparticles into the alloy. In other embodiments, columnar defects may be introduced (e.g., as described in A. Crisan, V.-S. Dang, and P. Mikheenko, “Nano-engineered pinning centres in YBCO superconducting films,” Physica C: Superconductivity and its Applications, vol. 533, pp. 118-132, 2017, incorporated herein by reference). In other embodiments, nano-inclusions such as WO₃, TiO₂, BiFeO₃ and BaTiO₃ may enhance critical current density. The conventional magnets affixed to the tank outer wall may comprise permanent magnets or electro-magnets. Preferably the conventional magnets comprise so-called “super magnets” such as neodymium magnets and samarium-cobalt magnets. The conventional magnets also may comprise permanent ferro-magnets. The conventional magnets are embedded within or attached to the outer surface of the tank outer wall. In other embodiments, the conventional magnets are embedded within or attached to the inner surface of the tank outer wall. As the tank is filled with hydrogen, the liquid hydrogen drops the temperature of the tank inner wall and accordingly the temperature of the superconducting wires to below the critical temperature of the superconducting wires. At this point the superconducting wires exhibit significant magnetic flux opposite to the magnetic flux of the conventional magnets on the tank outer wall essentially causing the inner wall and the outer wall of the tanks to be held apart by magnetic repulsion forces. The inner and outer wall will remain from one another as long as the temperature of the superconducting wire attached to the wall of the tank remains below its critical temperature.

In order to prevent the tank's inner wall from contacting the outer tank when the tank does not contain liquid hydrogen, the inner wall of the outer tank and/or the outer wall of the inner tank may include bumpers formed of an elastomeric material. Alternatively, the inner tank wall may be suspended within the outer tank wall by ties or filaments which are strong enough to maintain the inner wall tank spaced from the outer tank wall, but optionally not strong enough to support the inner tank wall within the outer tank wall when the tank is filled with liquid hydrogen. This results in a substantial weight and thermal transfer reduction as compared to a conventional cryogenic storage tank such as illustrated in FIG. 1 discussed above.

In accordance with one aspect of the disclosure, there is provided a cryogenic storage tank comprising an inner wall and an outer wall defining a space, wherein the inner wall and outer wall are spaced from one another by magnetic repulsion.

In one embodiment, the inner wall has superconducting material embedded in or on a surface of the inner wall, and the outer wall has conventional magnetic material embedded in or on a surface of the outer wall.

In one embodiment, the magnetic material is embedded within or attached to an outer surface of the tank's outer wall.

In another embodiment, the magnetic material is embedded within or attached to an inner surface of the tank's outer wall.

In another embodiment, the outer wall is formed of a material permeable to magnetic fields.

In a still further embodiment, the superconducting material comprises a type-II superconducting material.

In another embodiment, the type-II superconducting material comprises a superconducting wire.

In a further embodiment, the type-II superconducting material comprises a metal or metal alloy selected from the group consisting of NbTi, Nb₃Sn, YBa₂Cu₃Oₓ, (YBCO), MgBₛ, and Bi₂Sr₂CaO.

In another embodiment, the type-II superconducting material comprises an alloy including nano-inclusions of Y₂O₃, WO₃, TiO₂, BiFeO₃ and/or BaTiO₃.

In yet another embodiment, the conventional magnetic material is selected from the group consisting of a ferro-magnetic material, or a rare earth magnets material such as neodymium magnetic material and samarium-cobalt magnetic material.

In another embodiment, the conventional magnetic material comprises an electro-magnet.

In a further embodiment, the superconducting wire is arranged spaced from adjacent strands of superconducting wire.

In yet a further embodiment, a plurality of elastomeric bumpers is provided projecting into the space between the inner wall and the outer wall of the tank.

In another embodiment, the inner tank wall is suspended within the outer tank wall by ties or filaments which are strong enough to maintain the inner tank wall spaced from the outer tank wall when the tank is empty, but not strong enough to support the inner tank within the outer tank when the tank is filled with liquid.

The present disclosure also provides a vehicle comprising a cryogenic storage tank as above described.

In one embodiment, the vehicle comprises a fuel cell powered aircraft.

In another embodiment, the fuel cell comprises a hydrogen powered fuel cell.

In yet another embodiment, the tank is at least partially filled with liquid hydrogen.

In still yet another embodiment, the vehicle comprises a lighter than air aircraft.

In a yet another embodiment, the tank is at least partially filled with helium.

According to aspect A of the present invention there is provided a cryogenic storage tank comprising an inner wall and an outer wall defining a space, wherein the space is filled at least in part with a high angle of repose particulate material consisting of dried-in-place hollow glass microspheres which provides both insulating and structural properties to maintain the space.

Preferably the inner wall and the outer wall are formed of different materials.

Preferably the outer wall comprises a built-up wall including one or more non-metallic layers.

Preferably the inner wall comprises a metal wall and the outer wall comprises one or more layers formed of a metal foil, or one or more layers formed of a fiber reinforced material, or one or more layers of a metal foil and one or more layers formed of a fiber reinforced material.

According to aspect B of the present invention there is provided a method of forming a cryogenic storage tank according to aspect A of the present invention, comprising providing a first walled structure configured to form the tank inner wall; wrapping the first walled structure in a flexible bladder; inserting a putty comprising glass microsphere particles in a volatile organic solvent between the outer wall of the first walled structure and the bladder; driving off the solvent to form said glass microsphere particles into a high angle of repose material; optionally removing the bladder, and forming a built-up layer over the glass microsphere particles to form the tank outer wall, or forming a built-up layer directly over the bladder to flow the tank outer wall.

In one embodiment, the putty is inserted by injection or blowing.

Another embodiment includes the step of wetting out the glass microspheres with acetone.

In yet another embodiment, the glass microspheres are vibrated or rolled while the bladder is depressurized to drive off the volatile organic solvent.

In another embodiment, the glass microspheres are sculpted to a shape by vibration or rolling.

In a further embodiment, a heat/pressure cycle is used to drive off the volatile organic solvent.

In another embodiment, the glass microspheres have diameters of between 1 and 100 micrometers.

Another embodiment comprises applying a spray-on foam insulation or expanded cork insulation over the built-up layer.

Still another embodiment includes the step of mixing an aerogel or carbon nanotubes into the putty.

Preferably the solvent is driven off by heat, by vacuum, or by a combination of heat and vacuum.

Preferably the built-up layer comprises one or more layers formed of a metal foil, or one or more layers formed of a fiber reinforced plastic material, or one or more layers formed of a metal foil and one or more layers formed of a fiber reinforced material.

Preferably the method further includes adding a thermal insulating layer over the built-up layer.

According to aspect C of the present invention there is provided a method of forming a cryogenic storage tank according to aspect A of the present invention, comprising providing a first walled structure configured to form the tank inner wall; applying a putty comprising glass microsphere particles in a volatile organic solvent on an outer wall surface of the first walled structure; applying a release agent over the putty; applying a bladder over the release agent and heating and/or pulling a vacuum to draw off the organic solvent to form said glass microsphere particles into a high angle of repose material, removing the bladder, and forming a built-up layer over the glass microsphere particles to form the tank outer wall, or forming a built-up layer directly over the bladder to grow the tank outer wall.

Preferably the built-up layer wall comprises one or more layers formed of a metal foil, one or more layers formed of a fiber reinforced plastic material, one or more layers formed of a metal foil and one or more layer of a fiber reinforced plastic material.

Preferably the method further includes adding a thermal insulating layer over the built-up layer.

In one embodiment, the putty is applied by hand.

In another embodiment, the putty is applied by a robot.

In yet another embodiment, the built-up layer comprises layers of metal foil and polymer and/or a reinforced plastic.

In a further embodiment, a spray-on foam insulation or expanded cork insulator is applied over the built-up later.

Yet another embodiment includes the step of mixing an aerogel or carbon nanotubes into the putty.

According to aspect D of the present invention there is provided a fuel cell powered aircraft comprising a cryogenic storage tank according to aspect A of the present invention.

Preferably the cryogenic storage tank further comprises a plurality of elastomeric bumpers projecting into the space between the inner wall and the outer wall of the tank.

Preferably the inner tank wall is suspended within the outer tank wall by ties or filaments which are strong enough to maintain the inner tank wall spaced from the outer tank wall when the tank is empty, but not strong enough to support the inner tank within the outer tank when the tank is filled with liquid.

Preferably the filaments are elastic.

According to aspect F of the present invention there is provided a vehicle comprising a cryogenic storage tank according to aspect E of the present invention.

In one alternative embodiment the vehicle comprises a fuel cell powered aircraft.

Preferably the fuel cell comprises a hydrogen powered fuel cell.

Preferably the tank is at least partially filled with liquid hydrogen.

In another alternative embodiment the vehicle comprises a lighter than air aircraft.

Preferably the tank is at least partially filled with helium.

Further areas of applicability will become apparent from the description provided herein. The description and specific examples in this summary are intended for the purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings. The drawings described herein are for illustrative purposes only of selected embodiments and not all possible implementations and are not intended to limit the scope of the present disclosure.

FIG. 1 is a cross-sectional view of a prior art cryogenic storage tank;

FIG. 2 is a view, similar to FIG. 1 of another prior art cryogenic storage tank;

FIG. 3 is a flow diagram of a process for manufacturing a cryogenic storage tank in accordance with a first embodiment of the disclosure;

FIG. 3A is a cross-sectional view of a cryogenic storage tank made in accordance with the present disclosure, before optional conventional insulation is added to the exterior of the tank;

FIG. 4 is a flow diagram of a process for manufacturing a cryogenic storage tank in accordance with a second embodiment of the disclosure;

FIG. 5 is a flow diagram of a process for manufacturing a cryogenic storage tank in accordance with a third embodiment of the disclosure;

FIG. 6 is a schematic view of a hydrogen fuel cell powered airplane having a novel cryogenic hydrogen fuel storage tank in accordance with the present disclosure;

FIG. 7 is a cross-sectional view of a cryogenic storage tank made in accordance with the present disclosure;

FIG. 8 is a top plan view, in partial cross-section, of a cryogenic storage tank made in accordance with the present disclosure;

FIGS. 9A and 9B are magnetic flux diagrams illustrating the effect on magnetic flux introducing artificial pinning centers in a superconductor employed in the present disclosure; and

FIG. 10 is a schematic view of a hydrogen fuel cell powered airplane having a cryogenic storage tank in accordance with another embodiment of the present disclosure.

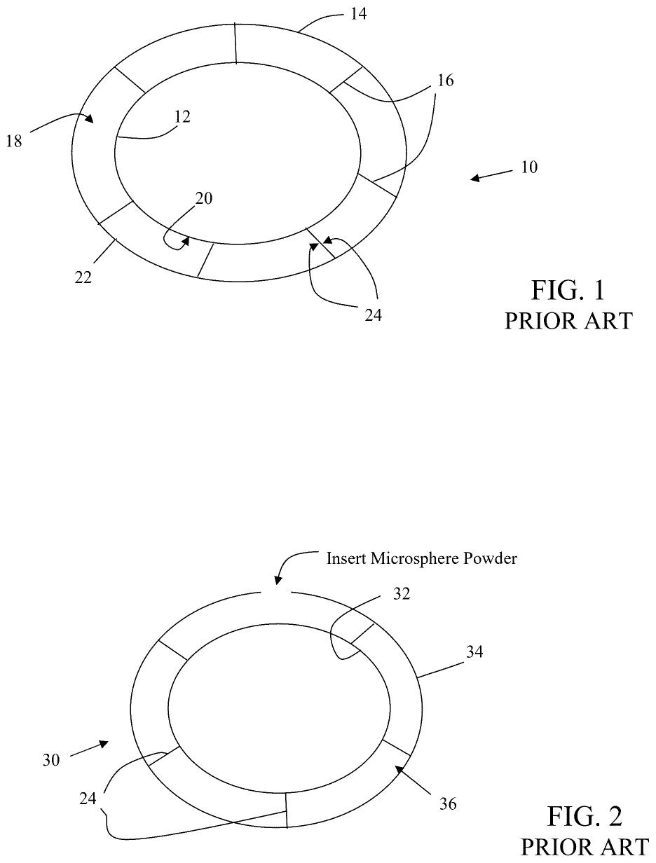

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein the terms “superconductivity” and “superconductor” are used interchangeably, superconductor materials are materials that can be drawn or formed into a wire, and have a critical temperature, i.e., a temperature at which the material loses superconductivity below that of the boiling point of the liquid being stored in the cryogenic storage tank. In the case of hydrogen which has a boiling point of about 20°K, useful superconductor materials are so-called type-II superconductor materials, i.e., materials which have a critical temperature at most of 77.3°K. The type-II superconductor materials also are materials which do not lose superconducting state in the presence of an external magnetic field. Exemplary type-II superconductor materials useful in the present disclosure include NbTi, Nb₃Sn, Yba₂Cu₃Oₓ, MgB₂, and Bi₂Sr₂CO, which are given as exemplary.

And, as used herein conventional magnets include conventional permanent including ferro-magnets, rare earth magnets such as neodymium magnets and samarium-cobalt magnets, and electro-magnets.

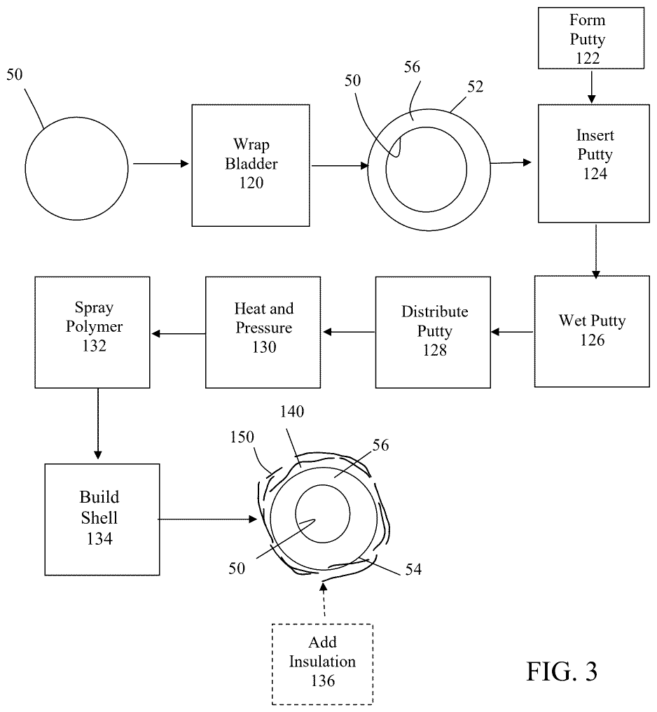

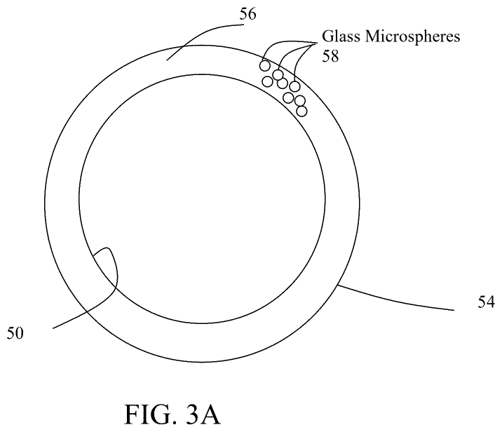

Referring to FIGS. 3 and 3A, in accordance with the first embodiment of the present disclosure, we provide a cryogenic storage tank comprising an inner wall structure 50, and an outer wall 54 forming a space 56 between them. Space 56 is filled with a high angle of repose granular material such as hollow glass microspheres 58, which material is loaded into the space between the inner and outer walls 50, 54, as follows.

First a walled structure 50 is wrapped at a wrapping step 120 with an elastic bladder 52. Then a microsphere “putty” is created at a mixing step 122 using a volatile organic solvent, such as acetone, to fully saturate a solution of glass microspheres such as 3M™ K1 glass microspheres which have a diameter of approximately 0.05-0.1 mm in a ratio such that the putty is neither too clumpy nor too sticky. In other embodiments, a silica anti-caking agent may be added to the putty. The putty is then inserted (e.g., injected, blown) in an inserting step 124 directly into the space 56 between the elastic latex bladder 52 and the wall structure 50 destined to become the tank inner wall. The microsphere fill is then “wetted out” with volatile organic solvents such as acetone in a wetting step 126. The putty is then distributed (e.g., one or more vibrated, rolled, sculpted) while slowly depressurizing the bladder in a distributing step 128 to evenly distribute the microspheres, so that they set in a high angle of repose material. The distributing step 128 may be used to achieve a custom geometry thickness.

The resulting putty holds its shape and conforms to orifices and complex geometry of the tank.

Also, in the case of larger size tanks, a vacuum may be applied, and a heat/pressure cycle used to consolidate and drive off solvent, to form the glass microspheres into a high angle of repose material in a heating/pressure step 130. Once the high angle of repose material sets, the bladder can be removed.

Once the tank inner wall is fully encapsulated by the set high angle repose material, the bladder may be removed, or left in place, and with or without a bladder it can be sprayed in spraying step 132 with a suitable setting or curing, low outgassing polymer, with two or three coats each reaching tack before continuing. The fast cure spray is then allowed to reach full cure.

From here a composite shell is progressively built-up, starting with layers 140 of, e.g., aluminum foil and epoxy, moving on to carbon fiber reinforced plastic layer in a building shell staged process step 134 to create the outer tank wall 54.

Conventional ambient pressure insulation 150 then can be added such as a spray on foam insulation, expanded cork, or a non-volatile, multi-layer insulation, etc., in an optional step 136. Layers 140 and insulation 150 may optionally conform to the outer vessel. Since the outer vessel is a composite, it can be made to vary in thickness to allow for mounting points appropriate to the installation location. In other embodiments, the insulation may accommodate tank mounting points.

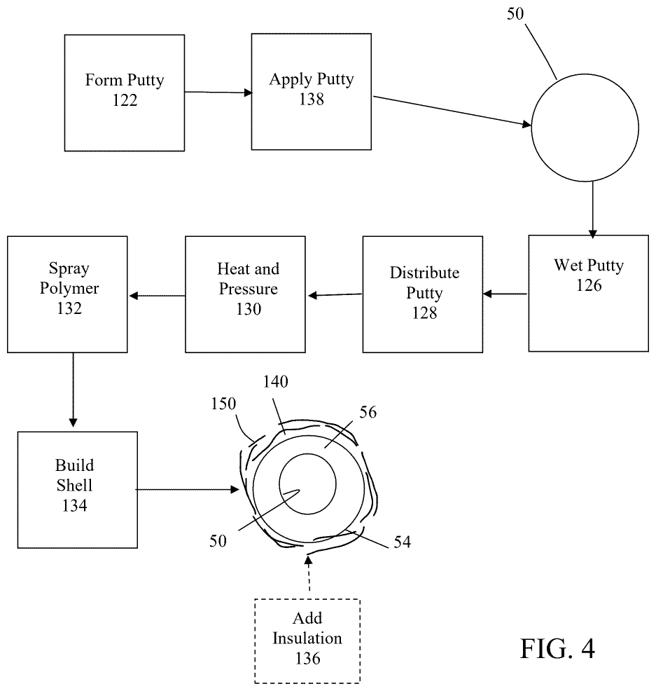

In an alternative embodiment, the microsphere “putty” can be applied mechanically, e.g., by hand, or by robot, over the wall structure destined to become the tank inner wall 50 in step 138. See FIG. 4.

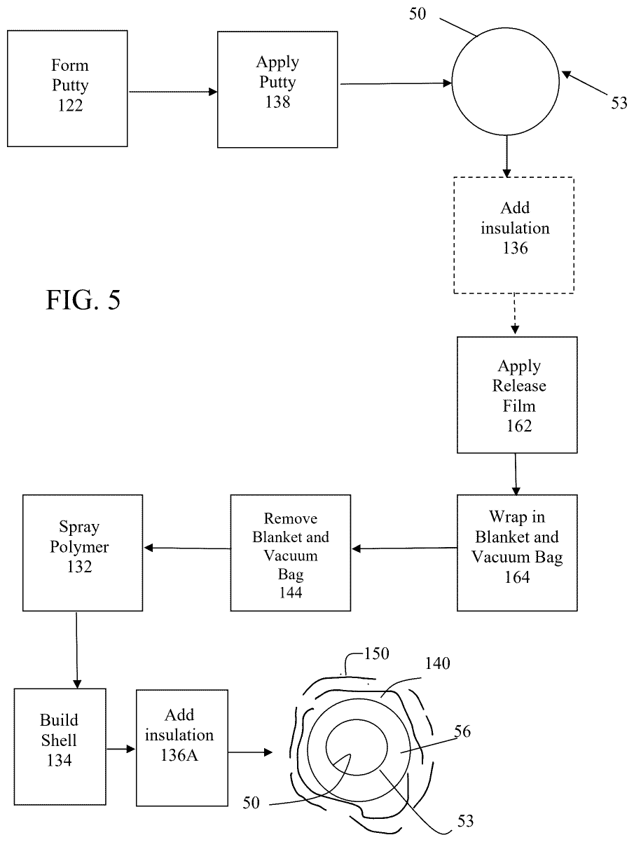

Referring to FIG. 5, in still yet another embodiment a microsphere “putty” or glass microspheres is created, as before, and the microsphere putty is applied directly to the outer surface 53 of the inner wall structure 50 destined to become the tank inner wall in a step 138. Conventional ambient pressure insulation then can be added such as a spray-on foam insulation, expanded cork, or a non-volatile, multi-layer insulation, etc., in an optional step 136.

Thereafter a release film, e.g., a P3 release film is applied over the microsphere putty and optionally applied conventional ambient pressure insulation (step 162) and using a breather blanket and a vacuum bag to apply vacuum, a heat/pressure cycle, step 164, is used to consolidate and drive off the organic solvent, whereby to form the glass microsphere into a high angle of repose material. Upon setting of the high angle of repose material, the blanket and vacuum bag is removed in step 144.

Once the structure is fully encapsulated with or without a bladder it is sprayed with a suitable setting or curing (step 132), low outgassing polymer, with two or three coats each reaching tack before continuing, it is then allowed to reach full cure, as before.

From here a composite shell is progressively built-up (step 134), optionally starting with layers of metal foil and polymer, e.g., aluminum foil and epoxy, moving on to carbon fiber reinforced plastic layer in a staged process to create the outer tank wall, as before.

Conventional ambient pressure insulation 150 can then be added such as a spray on foam insulation, expanded cork, a non-vacuum, multi-layered insulation (step 136A).

In other embodiments, an aerogel may be mixed into the microsphere putty. In yet other embodiments, an aerogel and other material with desirable structural properties, a polymer, or carbon nanotubes may be mixed into the microsphere putty.

FIG. 6 schematically illustrates an airplane 180 which includes two electric motors 152A, 152B which are supplied by two parallel hydrogen fuel cell systems 154A, 154B including two cryogenic hydrogen fuel tanks 156A, 156B.

Cryogenic storage tanks made in accordance with the present disclosure offer many advantages, including:
Tanks made according to the instant disclosure can be lightweight, as the outer vessel is fully supported by the high angle of repose material between the tank walls, this creates a lightweight strong sandwich composite structure. Such a design also negates additional weight by having no inner vessel support.
Adaptable design, so the heat flux of a system can be tailored in such a way to ensure specific areas of a tank possess a localized flux specific to a particular boil off regime.
The tanks are low cost to produce but also to maintain since they uniquely operate in the soft vacuum (SV) range yet provide performance normally only available to HV systems. This can be done thanks to utilizing the Fesmire Effect: as the tank cools down, micro-cryopumping of SO₂ within the microspheres results in millions of High Vacuum (HV) regions within an SV environment (pseudo MV).
Made using REACH (Registration, Evaluation, Authorization, and Restriction of Chemicals) compliant, non-toxic chemicals.
Can mold to custom geometries (especially useful, e.g., for integration within an airplane's existing spaces).
Robust to cryogenic cycling (existing tank designs are significantly cycle life limited).
Robust to vibration.
The tanks are intrinsically safe and provide redundancy in the event of loss of vacuum as may result from a tank breach. That is to say, due to the presence of the glass microspheres which provide some thermal insulation, tanks made in accordance with the present disclosure possess good thermal performance even in the event of a loss of vacuum, unlike more conventional tanks such as double walled stainless steel, vacuum jacketed multi-layer insulation tanks. And previous attempts to avoid the danger of vacuum though Multi-Layer Insulation without vacuum are not performant.
Tanks made in accordance with the present disclosure also provide significant weight savings over traditional designs with supports.
Tanks made in accordance with the present disclosure have a potential for a high IQF (insulation quality factor) attainable relative to other designs since areas around feedthroughs, lines and sensors can be better insulated.
The high angle of repose materials between the tank inner and outer walls can tolerate high compression loading and are fully aggregated and encapsulated, which removes the need for vessel supports between the tank walls.
Tanks made in accordance with the present disclosure provide thermal performance at low pressure and low temperatures (soft vacuum—SV, e.g., 100 mTorr@20K).

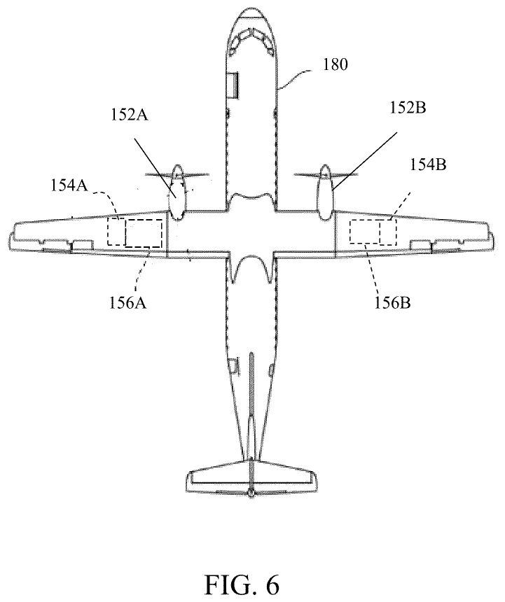

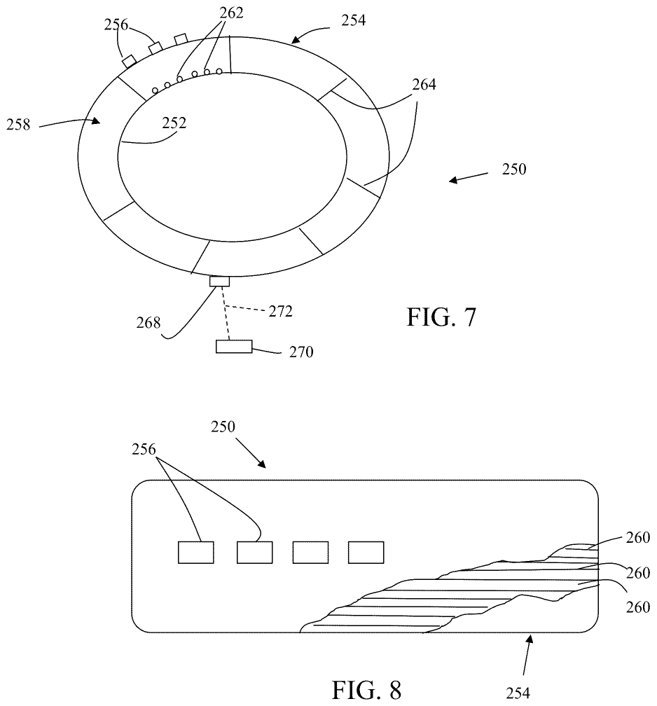

Referring to FIGS. 7 and 8, cryogenic storage tank 250 in accordance with the present disclosure includes an inner wall 252 and an outer wall 254. Inner wall 252 and outer wall 254 are spaced from one another by magnetic repulsion as will be described below. The space between inner wall 252 and outer wall 254, void 258 is evacuated to form a vacuum. Void 258 also may be filled at least in part with thermal insulating material.

In accordance with the present disclosure, inner wall 252 of the cryogenic storage tank 250 includes superconducting wires 260 embedded in or on a surface of the inner wall 252. Wires 260 are spaced from one another, and preferably run parallel to one another. A plurality of conventional magnets 256 are mounted on the surface of the tank outer wall 254 (e.g., on the outer surface as shown). In some embodiments, conventional magnets 256 are mounted on the inner surface of the tank outer wall 254. Tank outer wall 254 is formed of a material permeable to magnetic fields such as a polymeric material. Tank 250 includes inlets and outlets (not shown) which are conventional for loading and withdrawing cryogenic fluid in and out of storage. Tank 250 comprises a plurality of bumpers 262 formed, e.g., of an elastomeric material on the inner wall 252 and/or outer wall 254 projecting into void 258 for keeping the inside and outer walls of the tank 250 from contacting one another when the tank is empty. Alternatively, or additionally, the inner tank wall may be suspended within the outer tank wall by ties or filaments 264 which are strong enough to maintain the inner tank spaced from the outer tank wall when the tank is empty, but not strong enough to support the inner tank wall within the outer tank wall when the tank is filled with liquid hydrogen. In some embodiments, filaments 264 are elastic.

Alternatively, the magnets on the surface of the tank outer wall 254 may comprise electro-magnets 268, in which case, an electrical power supply 270, which could be a hydrogen fuel cell, and wiring 272 will need to be included.

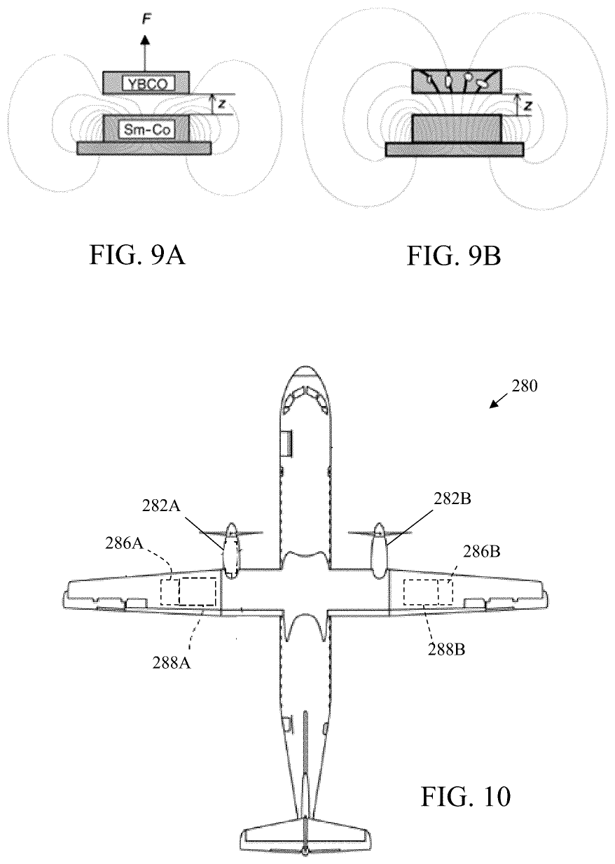

In one embodiment, the superconductor material comprises YBCO is covered with magnetic Fe nanoparticles to produce artificial pinning centers following the teachings of Masih Mojarrad et al., “Using Magnetic Nanoparticles to Improve Flux Pinning in YBa₂Cu₃Oₓ Films”, IEEE Conference Publication, incorporated herein by reference. FIGS. 9A and 9B are flux diagrams showing differences in magnetic flux between a samarium-cobalt sintered permanent magnet and untreated YBCO superconducting wire (FIG. 9A), and samarium-cobalt sintered permanent magnet and YBCO treated with Fe nanoparticles to produce artificial pinning centers, at the boiling temperature of liquid hydrogen (20°K) (FIG. 9B).

FIG. 10 schematically illustrates an airplane 280 which includes two electric motors 282A, 282B which are supplied by two parallel fuel cell systems 286A, 286B including two cryogenic hydrogen fuel tanks 288A, 288B, made in accordance with the present disclosure.

Cryogenic storage tanks made in accordance with the present disclosure offer many advantages over prior art tanks including: tanks made in accordance with the present disclosure can be light weight, as the outer vessel can be made of light weight polymeric material.

Tanks made in accordance with the present disclosure are also lighter in weight as requiring no structural inner vessel support.

The tanks can be made to custom geometries, which is specifically useful, for example, for integration within an airplane's existing spaces.

Tanks may be made using REACH (Registration Evaluation Authorization and Restriction of Chemicals) compliant non-toxic chemicals.

Tanks are robust to cryogenic cycling and vibration.

The foregoing description of the embodiments has been provided for purposes of illustration and description. It is not intended to be exhaustive or to limit the disclosure. By way of example, but not limitation, the cryogenic storage tanks advantageously may be employed as fuel tanks and/or oxidant tanks for rockets and space vehicles. The tanks also may be employed with conventional land and sea vehicles including, for example, LNG tankers, and as fixed storage tanks, and portable tanks for consumer, industrial, educational, and military uses, including, for example, for forming Dewar vessels.

Cryogenic storage tanks made in accordance with the present disclosure also advantageously may be used for storing liquid helium for lighter than air aircraft. In such case since helium boils at 4.2°K, type-I superconductor materials such as tantalum, niobium, and titanium and their alloys may be used. Also, cryogenic storage tanks made in accordance with the foregoing disclosure advantageously may be used in other applications including other forms of transportation as well as fixed storage tank applications for consumers, industrial, educational, and military applications.

Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

What is claimed:

1. A cryogenic storage tank comprising an inner wall and an outer wall defining a space, wherein the inner wall and outer wall are spaced from one another by magnetic repulsion, said storage tank further comprising a plurality of elastomeric bumpers projecting into the space between the inner wall and the outer wall of the tank.

2. The cryogenic storage tank of claim 1, wherein the inner wall has superconducting material embedded in or on a surface of the inner wall, and the outer wall has conventional magnetic material embedded in or on a surface of the outer wall.

3. The cryogenic storage tank of claim 2, wherein the magnetic material is embedded within or attached to an outer surface of the tank outer wall.

4. The cryogenic storage tank of claim 2, wherein the magnetic material is embedded within or attached to an inner surface of the tank outer wall.

5. The cryogenic storage tank of claim 2, wherein the outer wall is formed of a material permeable to magnetic fields.

6. The cryogenic storage tank of claim 1, wherein the superconducting material comprises a type-II superconducting material.

7. The cryogenic storage tank of claim 6, wherein the type -II superconducting material comprises a superconducting wire.

8. The cryogenic storage tank of claim 6, wherein the type-II superconducting material comprises a metal or metal alloy selected from the group consisting of NbTi, Nb3Sn, YBa₂Cu₃Ox and Bi₂Sr₂CaO.

9. The cryogenic storage tank of claim 6, wherein the type-II superconducting material comprises an alloy including nano-inclusions of Y₂O₃, WO₃, TiO₂, BiFeO₃ and/or BaTiO₃.

10. The cryogenic storage tank of claim 2, wherein the conventional magnetic material is selected from the group consisting of a ferro-magnetic material, and a rare earth magnetic material.

11. The cryogenic storage tank of claim 10, wherein the rare earth magnetic material comprises neodymium magnetic material and samarium-cobalt magnetic material.

12. The cryogenic tank of claim 2, wherein the conventional magnetic material comprises an electro-magnet.

13. The cryogenic storage tank of claim 7, wherein the superconducting wire is arranged spaced from adjacent strands of superconducting wire.

14. The cryogenic storage tank of claim 1, wherein the inner tank wall is suspended within the outer tank wall by ties or filaments which are strong enough to maintain the inner tank wall spaced from the outer tank wall when the tank is empty, but not strong enough to support the inner tank within the outer tank when the tank is filled with liquid.

15. The cryogenic storage tank of claim 14, wherein the filaments are elastic.

16. A vehicle comprising a cryogenic storage tank as claimed in claim 1.

17. The vehicle of claim 16, wherein the vehicle comprises a fuel cell powered aircraft.

18. The vehicle of claim 17, wherein the fuel cell comprises a hydrogen powered fuel cell.

19. The vehicle of claim 18, wherein the tank is at least partially filled with liquid hydrogen.

20. The vehicle of claim 16, wherein the vehicle comprises a lighter than air aircraft, and wherein the tank is at least partially filled with helium.
